(19) United States
(12) Patent Application Publication
(10) Pub. No.: US 2010/0330353 A1
(43) Pub. Date: Dec. 30, 2010

(54) METHOD FOR PRODUCING ORGANIC-INORGANIC HYBRID THIN FILM AND ORGANIC-INORGANIC HYBRID THIN FILM

(76) Inventors: Toyoki Kunitake, Saitama (JP); Hiroomi Watanabe, Saitama (JP)

Correspondence Address: BIRCH STEWART KOLASCH & BIRCH, PO BOX 747, FALLS CHURCH, VA, 22040-0747, US

(21) Appl. No.: 12/665,292

(22) PCT Filed: Jun. 23, 2008
(86) PCT No.: PCT/JP2008/061426

§ 371 Date: Dec. 17, 2009

(30) Foreign Application Priority Data
Jun. 22, 2007 (JP) 2007-165115

(51) Int. Cl. C07F 7/02; C08G 59/14; B05D 3/10; B32B 27/38

(52) U.S. Cl. 428/220; 549/215; 525/523; 427/331

(57) ABSTRACT

An organic-inorganic hybrid thin film including: an organic compound (A) having at least one functional group and; an inorganic compound (B) having a metal atom, as a core, to which each of at least one functional group and at least one hydrolysable group is bound directly or via a connecting group, the organic-inorganic hybrid thin film being structured such that a covalent bond is formed between the functional group in the organic compound (A) and the functional group in the inorganic compound (B), and a metal oxide is formed from the inorganic compound (B) through a hydrolytic reaction on the hydrolysable group in the inorganic compound (B).

### TECHNICAL FIELD

The present invention relates to a production method of an organic-inorganic hybrid thin film, and an organic-inorganic hybrid thin film obtainable through the production method.

### BACKGROUND ART

A composite material constituted by an organic compound and a metal oxide is expected to have a mechanical property, a physical property, and a chemical property, which are attained neither by the organic compound alone nor by the metal oxide alone. For this reason, development of such a composite material is strongly required in a variety of fields. Particularly, a composite material constituted by a polymeric compound and a metal oxide is regarded as one of the most important materials today, because such a composite material has a mechanical property attributed to toughness of a polymer and rigidity of an oxide. The composite material constituted by the polymeric compound and the metal oxide is excellent in elasticity, abrasion resistance, and chemical stability, and therefore is expected to be used in a tire and a shielding material in the future. Further, a metal oxide containing an organic molecule is under consideration for its applications in a wide range of fields, such as coloring a general-propose material and use in a novel optical element.

Meanwhile, not a few of such properties of the composite material become practically valuable only after the composite material is shaped into a thin film. For example, in a semiconductor industry today, high integration of layers of electronic devices is an important technological goal. In order to meet this goal, it is essential to use a stable insulating thin film whose film thickness is controlled at the nano level. Further, in a precision electronic device, such as a hard disk, which generates mechanical friction, it is necessary to use a thin film having both semi-softness and abrasion resistance, which appear to be in a trade-off relationship.

As a thin film which meets such requirements, there has been known a thin film disclosed in Non-Patent Literature 1. The thin film disclosed in Non-Patent Literature 1 has an interpenetrating structure. Since such an interpenetrating form is constituted by a metal oxide and an organic polymer which are interdigitated with each other, the interpenetrating form is highly stable mechanically and physically. However, further advancement in technologies requires more mechanical and physical stabilities.

Further, in Non-Patent Literature 1, the method of forming the interpenetrating structure is such that the metal oxide precursor is turned into the metal oxide through a sol-gel reaction, during which the organic monomer is polymerized. That is, technical means of forming the thin film is very limited.

### Citation List

Non-Patent Literature 1

Vendamme, R.; Onoue, S.; Nakao, A.; Kunitake, T. Nature Materials, 2006, 5, 494-501.

### SUMMARY OF INVENTION

### Technical Problem

The present invention has been made to solve the foregoing problems, and an object thereof is to produce an organic-inorganic hybrid thin film which is highly stable mechanically and physically.

### Solution to Problem

The inventors of the present invention diligently worked to attain the object, and found that it is possible to obtain an organic-inorganic hybrid thin film whose stability is improved, by (i) forming a covalent bond between an organic compound and an inorganic compound, and (ii) causing a hydrolytic reaction on the inorganic compound to from a metal oxide. Specifically, the inventors of the present invention found that it is possible to attain the object with the following means.

(1) An organic-inorganic hybrid thin film including: an organic compound (A) having at least one functional group; and an inorganic compound (B) having a metal atom, as a core, to which each of at least one functional group and at least one hydrolysable group is bound directly or via a connecting group, the organic-inorganic hybrid thin film being structured such that a covalent bond is formed between the functional group in the organic compound (A) and the functional group in the inorganic compound (B), and a metal oxide is formed from the inorganic compound (B) through a hydrolytic reaction on the hydrolysable group in the inorganic compound (B).
(2) The organic-inorganic hybrid thin film according to (1), wherein: at least one kind of the functional group in the organic compound (A) and at least one kind of the functional group in the inorganic compound (B) are independently selected from the group consisting of: a vinyl group; a (meth)acrylic group; an epoxy group; a vinyl ether group; an amino group; a hydroxyl group; a carboxyl group; an alkoxycarbonyl group; a mercapto group; an alkyl halide group; an iso(thio)cyanate group; an acid halide group; a phosphono group; and an alkoxyphosphono group.
(3) The organic-inorganic hybrid thin film according to (1), wherein at least one kind of the functional group in the organic compound (A) and at least one kind of the inorganic compound (B) are independently selected from the group consisting of: a vinyl group; a (meth)acrylic group; an epoxy group; and an amino group.
(4) The organic-inorganic hybrid thin film according to any one of (1) to (3), wherein the covalent bond is formed through a chain polymerization reaction, a condensation reaction, or an addition reaction.
(5) The organic-inorganic hybrid thin film according to any one of (1) to (4), wherein the covalent bond is an irreversible covalent bond.
(6) The organic-inorganic hybrid thin film according to any one of (1) to (5), wherein the organic compound (A) has two or more functional groups.
(7) The organic-inorganic hybrid thin film according to any one of (1) to (6), wherein the metal atom in the inorganic compound (B) is selected from the group consisting of Al, Sb, Zr, Ti, Cr, Si, La, Ni, Sn, and V.
(8) The organic-inorganic hybrid thin film according to any one of (1) to (7), wherein at least one kind of the hydrolysable group in the inorganic compound (B) is selected from the group consisting of an alkoxy group; an acetoxy group; and a chloro group.
(9) The organic-inorganic hybrid thin film according to any one of (1) to (8), wherein the inorganic compound (B) is a silane coupling agent.
(10) The organic-inorganic hybrid thin film according to any one of (1) to (9), wherein: at least one kind of the functional group in the organic compound (A) and at least one kind of the functional group in the inorganic compound (B) are independently selected from the group consisting of: a vinyl group, a (meth)acrylic group, an epoxy group, and an amino group, the metal atom in the inorganic compound (B) is Si, and at least one kind of the hydrolysable group in the inorganic compound (B) is selected from the group consisting of an alkoxy group, an acetoxy group, and a chloro group.
(11) A method for producing an organic-inorganic hybrid thin film, the method including: shaping, into a form of layer, a composition containing (i) an organic compound (A) having at least one functional group and (ii) an inorganic compound (B) having a metal atom, as a core, to which each of at least one functional group and at least one hydrolysable group is bound directly or via a connecting group; forming a covalent bond between at least one kind of the functional group in the organic compound (A) contained in the composition and at least one kind of the functional group in the inorganic compound (B) contained in the composition and thereafter; causing a hydrolysis reaction on the hydrolysable group to form a metal oxide.
(12) The method according to (11), wherein the covalent bond is formed through a chain polymerization reaction, a condensation reaction, or an addition reaction.
(13) The method according to (11) or (12), wherein: the step of shaping the composition into the form of layer and the step of causing the hydrolysis reaction are carried out after the step of forming the covalent bond.
(14) The method according to (13), wherein the covalent bond if formed in such a manner that the organic compound (A) and the inorganic compound (B) are directly mixed with each other.
(15) The method according to (11) or (12), wherein: the step of forming the covalent bond is carried out after the step of shaping the composition into the form of layer; and thereafter the step of causing the hydrolysis reaction is carried out.
(16) The method according to any one of (11) to (15), wherein the at least one kind of the functional group in the organic compound (A) and the at least one kind of the functional group in the inorganic compound (B) are independently selected from the group consisting of: a vinyl group; a (meth)acrylic group; an epoxy group; a vinyl ether group; an amino group; a hydroxyl group; a carboxylic acid group and ester thereof; a mercapto group; an alkyl halide group; an iso(thio)cyanate group; an acid halide group; phosphoric acid; and esters.
(17) The method according to any one of (11) to (15), wherein the covalent bond is an irreversible covalent bond.
(18) The method according to any one of (11) to (17), wherein the organic compound (A) has two or more functional groups.
(19) The method according to any one of (11) to (18), wherein the metal atom in the inorganic compound (B) is selected from the group consisting of Al, Sb, Zr, Ti, Cr, Si, La, Ni, Sn, and V.
(20) The method according to any one of (11) to (19), wherein the at least one of the hydrolysable group in the inorganic compound (B) is selected from the group consisting of an alkoxy group; an acetoxy group; and a chloro group.
(21) The method according to any one of (11) to (20), the method further including: forming a sacrifice layer on a surface of a support; the step of shaping the composition into the form of film by applying layerwise the composition on a surface of the sacrifice layer; and thereafter the step of causing the hydrolysis reaction on the composition to form a thin film on the surface of the sacrifice layer; and removing the sacrifice layer so as to separate the thin film from the support.
(22) The method according to (21), wherein: the removal of the sacrifice layer is carried out by dissolving the sacrifice layer.
(23) The method according to (21) or (22), wherein the composition is provided layerwise on the support by a spin-coating method or a dip-coating method.
(24) An organic-inorganic hybrid thin film produced with a method as set forth in any one of (11) to (23), the organic-inorganic hybrid thin film being in a range of 3 nm to 100 nm in thickness.

### ADVANTAGEOUS EFFECTS OF INVENTION

The present invention made it possible to obtain an organic-inorganic hybrid thin film which is highly stable mechanically and physically.

### BRIEF DESCRIPTION OF DRAWINGS

FIG. 1 is a diagram illustrating a scheme of a method for producing an organic-inorganic hybrid thin film in Examples of the present invention.

FIG. 2 is a graph showing measurement results of IR spectrum analysis in Example 1 of the present invention.

FIG. 3 shows photographs showing observation results of SEM in Example 1 of the present invention.

FIG. 4 shows photographs showing observation results of TEM in Examples 1 and 2 of the present invention.

FIG. 5 is a graph showing measurement results of IR spectrum analysis in Example 4 of the present invention.

FIG. 6 is a graph showing measurement results of thermal desorption spectrum analysis in Example 7 of the present invention.

FIG. 7 shows photographs of an organic-inorganic hybrid thin film showing observation results of SEM before and after burning in Example 7 of the present invention.

FIG. 8 shows photographs of an organic-inorganic hybrid thin film showing observation results of SEM before and after being dipped in a hydrogen fluoride aqueous solution for 30 minutes, in Example 7 of the present invention.

### REFERENCE SIGNS LIST

1 Silicon Wafer Substrate
2 Sacrifice Layer
3 Layer made of composition used in the present invention
4 Light Irradiation Apparatus
5 Organic-inorganic Hybrid Thin Film

### DESCRIPTION OF EMBODIMENTS

The following describes the present invention in details. In this specification, the numerical range expressed by the wording “a number to another number” means the range includes the former number (which indicates the lowermost limit of the range) and the latter number (which indicates the uppermost limit of the range).

An organic-inorganic hybrid thin film of the present invention includes: an organic compound (A) having at least one functional group; and an inorganic compound (B) having a metal atom, as a core, to which each of at least one functional group and at least one hydrolysable group is bound directly or via a connecting group, the organic-inorganic hybrid thin film being structured such that a covalent bond is formed between the functional group in the organic compound (A) and the functional group in the inorganic compound (B), and a metal oxide is formed from the inorganic compound (B) through a hydrolytic reaction on the hydrolysable group in the inorganic compound (B).

The organic-inorganic hybrid thin film structured as described above is explained hereinafter. It should be noted that an organic-inorganic hybrid thin film produced through another production method other than the production method described in this specification may also be encompassed in the organic-inorganic hybrid thin film of the present invention, provided that the organic-inorganic hybrid thin film produced through the another production method has the same structure as that of the organic-inorganic hybrid thin film of the present invention.

The organic-inorganic hybrid thin film of the present invention is a highly stable thin film, which has both flexibility and strength. Such an organic-inorganic hybrid thin film is obtainable by covalently-binding tightly the organic compound (A) and the inorganic compound (B), and thereafter, hydrolyzing the inorganic compound (B) to form a metal oxide.

In the present invention, it is possible to carry out formation of a covalent bond and a hydrolysis reaction independently of each other. Therefore, it is possible to produce the organic-inorganic hybrid thin film without concern for an interaction between the formation of the covalent bond and the hydrolysis reaction. Thus, the organic compound (A) and the inorganic compound (B), which are row materials, may be selected from a wide range of compounds. Particularly, since the covalent bond can be formed irreversibly in the present invention, the organic-inorganic hybrid thin film is greatly improved in stability of its structure.

The organic-inorganic hybrid thin film of the present invention is produced by, for example, preparing a composition containing the organic compound (A) and the inorganic compound (B), and then shaping the composition into a form of layer. Here, the covalent bond is formed between at least one of the functional group in the organic compound (A) contained in the composition and at least one of the functional group in the inorganic compound (B) contained in the composition, and thereafter, the hydrolysis reaction is caused on the composition. The covalent bond may be formed either before or after the composition is shaped into the form of layer, depending on the kind of the organic compound (A) and the kind of the inorganic compound (B).

In the production method of the present invention of the organic-inorganic hybrid thin film, it is important to first form the covalent bond and then cause the hydrolysis reaction. Therefore, the covalent bond may be formed either before or after the composition is shaped into the form of layer.

Further, the hydrolysis reaction may start before the covalent bond has completely been formed in the organic-inorganic hybrid thin film that is to be finally obtained, unless it goes against the gist of the present invention. For example, in a case where the formation of the covalent bond is carried on relatively slowly, the hydrolysis reaction may be carried out at a time when the covalent bond has not yet been completely formed, for example at a time when 10% or less of the covalent bond in the organic-inorganic hybrid thin film that is to be finally obtained has not yet been formed. This case is also encompassed in the scope of the production method of the present invention. Further, in some cases, a very little hydrolysis reaction starts spontaneously during the formation of the covalent bond upon mixing of the organic compound (A) and the inorganic compound (B). This case is also encompassed in the scope of the production method of the present invention of the organic-inorganic hybrid thin film.

### Embodiment 1

The case “where the covalent bond is formed before the composition is shaped into the form of layer” encompasses not only (i) a case where the covalent bond in the organic-inorganic hybrid thin film that is to be finally obtained has completely been formed before the composition is shaped into the form of layer, but also (ii) a case where the covalent bond in the organic-inorganic hybrid thin film that is to be finally obtained has been partly formed before the composition is shaped in to the form of layer. For example, in the case where the formation of the covalent bond is carried on relatively slowly, if preferably 70% or more, further preferably 90% or more of the covalent bond in the organic-inorganic hybrid thin film that is to be finally obtained has been formed at the time when the composition starts being shaped into the form of layer, then this case meets the requirement of “the covalent bond is formed . . . and thereafter, the composition is shaped into the form of layer” of the present invention.

A method of forming the covalent bond before the composition is shaped into the form of layer may be selected from known methods. For example, the covalent bond can be formed before the composition is shaped into the form of layer, by causing the organic compound (A) to directly react with the inorganic compound (B). The organic compound (A) and the inorganic compound (B) can be reacted directly with each other for example through a method including the steps of: mixing only the organic compound (A) and the inorganic compound (B) with each other; stirring the mixed product if needed; and diluting the mixed product with a solvent or the like. This method is preferably applicable in a case where an addition reaction or a condensation reaction starts between the organic compound (A) and the inorganic compound (B) upon mixing of the organic compound (A) and the inorganic compound (B), or upon mixing and stirring of the organic compound (A) and the inorganic compound (B).

In the present embodiment, since the organic compound (A) and the inorganic compound (B) have already been hybridized at the time when the composition starts being shaped into the form of layer, it is possible to reduce a risk of phase separation. This is advantageous because a mixing ratio of the organic compound (A) to the inorganic compound (B) can be changed variously.

For example, also in the method disclosed in Non-Patent Literature 1, it is possible that the hydroxyl group in the organic compound is reacted with the silane coupling agent to form a covalent bond; however, such a covalent bond is “unstable”, and is to be lost during the hydrolysis reaction. Even if the covalent bond is successfully formed, the covalent bond is to be reversibly unbound due to lack of stability. In contrast, in the present invention, it is possible to irreversibly form the covalent bond.

Further, in Non-Patent Literature 1, the radical polymerization and the hydrolysis reaction must proceed simultaneously. Moreover, in Non-Patent Literature 1, it is difficult to precisely shape the organic monomer into the form of layer; that is, a method of precisely shaping the organic monomer into the form of layer is substantially limited to the method whereby the organic monomer is applied and cured while being spun.

### Embodiment 2

The case “where the covalent bond is formed after the composition is shaped into the form of layer” encompasses also a case where a part of the covalent bond has already been formed at the time when the composition starts being shaped into the form of layer. Specifically, a case where most (preferably 70% or more, further preferably 90% or more) of the covalent bond is formed after the composition has been shaped into the form of layer is equivalent to “the case where the covalent bond is formed after the composition is shaped into the form of layer” in the present invention.

A method of forming the covalent bond after the composition is shaped into the form of layer may be selected from known methods. It is preferable to employ a method of forming the covalent bond through a chain reaction. Examples of the chain reaction encompass: a radical polymerization such as a photo radical polymerization and a thermo radial polymerization; and a photo cationic polymerization.

The present invention includes covalent bonding at least between at least one of the functional group in the organic compound (A) and at least one of the functional group in the inorganic compound (B). Further, in the present invention, each of the functional group in the organic compound (A) and the functional group in the inorganic compound (B) may be of two or more kinds. Furthermore, each of the organic compound (A) and the inorganic compound (B) may have a functional group which does not contribute to covalent bonding, unless it goes against the gist of the present invention. In the present invention, for example, in a case where the organic compound (A) has one kind of the functional group (A¹) and the inorganic compound (B) has two kinds of functional groups (B¹ and B²), the functional group A¹ may be bound to each of the functional groups B¹ and B², and alternatively, the functional group B¹ may be bound to each of the functional groups A¹ and B². The same applies to a case where the organic compound (A) has two or more kinds of functional groups.

Here, the functional group in the organic compound (A) and the functional group in the inorganic compound (B) are not particularly limited as long as they bind to each other to form the covalent bond; however, they are preferably functional groups which are used in a macromolecular reaction such as a chain polymerization, addition reaction, and addition condensation reaction, and in formation of an irreversible covalent bond, and they are more preferably functional groups frequently used in the macromolecular reaction such as the chain polymerization, addition reaction, and addition condensation reaction. Specifically, it is preferable that the covalent bond be formed through the chain polymerization, condensation reaction, or the addition reaction.

The chain polymerization is preferably the radical polymerization reaction or the cationic polymerization reaction. A functional group preferable for the radical polymerization reaction is for example a vinyl group, a (meth)acrylic group, and an aryl group derived from a phthalate. A functional group preferable for the cationic polymerization reaction is for example a ring-opening polymerized functional group such as an epoxy group, an oxetane group, a caprolactone group, and furan; and a vinyl ether group.

For the chain polymerization reaction, it is preferable to incorporate a polymerization initiator in the composition. The polymerization initiator may be selected as appropriate from known polymerization initiators, depending on the kind of a polymerization and the kinds of the organic compound (A) and the inorganic compound (B) which are row materials. In case of performing a photopolymerization with use of the polymerization initiator, it is preferable to irradiate the composition with light at a wavelength of 300 nm to 500 nm and at a light intensity of 1 mJ/cm²·s to 1 J/cm²·s for 30 seconds to 10 minutes. In case of performing a thermal polymerization with use of a thermal polymerization initiator, it is preferable to heat the composition at 80° C. to 150° C. for 1 minute to 10 minutes.

It goes without saying that the polymerization initiator is not necessary in a case where the chain polymerization can proceed without the polymerization initiator. For example, in a case where the chain polymerization reaction proceeds under light irradiation or the like, it is preferable that light irradiation of the composition for the covalent bond formation be carried out after the composition has been shaped into the form of layer.

In a case of performing the condensation reaction or the addition reaction, the functional group in the inorganic compound (B) is preferably, for example, an epoxy group, an amino group, an alkyl halide group, an isocyanate group, a mercapto group, a hydroxyl group, a carboxyl group, and an alkoxycarbonyl group. In a case where the functional group in the inorganic compound (B) is an epoxy group, the functional group in the organic compound (A) is preferably, for example, an amino group, a hydroxyl group, a carboxyl group, and a mercapto group. In a case where the functional group in the inorganic compound (B) is an amino group, the functional group in the organic compound (A) is preferably, for example, an alkyl halide group, a thiol group, an iso(thio)cyanate group, a carboxyl group, an alkoxycarbonyl group, a group based on acid anhydride, an acid halide group, an epoxy group, an oxime group, and an aldehyde group. In a case where the functional group in the inorganic compound (B) is an alkyl halide group, the functional group in the organic compound (A) is preferably, for example, an amino group, a hydroxyl group, and an oxime group. In a case where the functional group in the inorganic compound (B) is an isocyanate group, the functional group in the organic compound (A) is preferably, for example, an amino group, a hydroxyl group, a carboxyl group, and a thiol group. In a case where the functional group in the inorganic compound (B) is a mercapto group, the functional group in the organic compound (A) is preferably, for example, an epoxy group, an amine group, an isocyanate group, a group based on acid anhydride, and a vinyl group. In a case where the functional group in the inorganic compound (B) is a hydroxyl group, the functional group in the organic compound (A) is preferably, for example, an epoxy group, an alkyl halide group, an iso(thio)cyanate group, a phosphono group, and an alkoxyphosphono group. In a case where the functional group in the inorganic compound (B) is a carboxyl group or an alkoxycarbonyl group, the functional group in the organic compound (A) is preferably, for example, an epoxy group, an amino group, and esters. Further, the covalent bond may be formed through an addition reaction which involves an free radical. In such a case, the functional group in the inorganic compound (B) is preferably a diazo group or an azido group. On the other hand, the functional group in the organic compound (A) may be selected from a wide range of groups as long as it has a function of drawing out hydrogen.

Out of those listed above, more preferable examples of the functional group in each of the organic compound (A) and the inorganic compound (B) of the present invention encompass: a vinyl group, a (meth)acrylic group, an epoxy group, a vinyl ether group, an amino group, a hydroxyl group, a carboxyl group, an alkoxycarbonyl group, a mercapto group, an alkyl halide group, an iso(thio)cyanate group, an acid halide group, a phosphono group, and an alkoxyphosphono group. Out of these, the vinyl group, the (meth)acrylic group, the epoxy group, and the amino group are further more preferable.

The addition reaction and the condensation reaction are preferable because a hybrid can be formed by mere stirring or heating (for example, at 20° C. to 50° C.). Thus, the addition reaction and the condensation reaction are particularly preferable in a case of employing a method in which the covalent bond is formed between the organic compound (A) contained in the composite and the inorganic compound (B) contained in the composite and thereafter the composite is shaped into the form of layer.

Examples of a compound having an amino group encompass: polymers such as polyethylenimine, polyaniline, and polyamide; and related oligomers thereof. Examples of a compound having a hydroxyl group encompass: polymers such as polyacrylic acid, polyhydroxystyrene, polyvinyl alcohol, and the like; and an oligomer having a hydroxyl group or a carboxyl group.

When forming the covalent bond between a vinyl group and an allyl group or between the vinyl group and a (meth)acryloyl group, the covalent bond can be formed by either of the following two types of methods. One is the addition reaction and the condensation reaction as described above, in which the vinyl group, the allyl group, and the (meth)acryloyl group well react with an oligomer having a mercapto group and with a polymer so that they are hybridized. The other one is a vinyl polymerization, in which each of the vinyl group, the allyl group, and the (meth)acryloyl group are polymerized with a polymer or an oligomer each having a double bond (e.g., a vinyl group, an allyl group, an acrylic group, and an isoprene group) through a radical polymerization, cationic polymerization, or anionic polymerization so that they are hybridized. In the vinyl polymerization, it is preferable to use the polymerization initiator.

Organic Compound (A)

The organic compound (A) used in the present invention is not particularly limited as long as it has a functional group that is to be covalently-bound to the functional group in the inorganic compound (B); however, the organic compound (A) is preferably a compound having two or more functional groups. The two or more functional groups may be of the same kind or different kinds.

That is, the inorganic compound (B) forms an inorganic network formed from a metal oxide, through a hydrolysis reaction. During the hydrolysis reaction, a hydrolysable group is condensed, thereby forming the metal oxide. The organic compound (A) is introduced into the inorganic network in such a manner that the organic compound (A) is covalently-bound to the inorganic network. Here, if the number of functional groups in the organic compound (A) is one, then the covalent bond between the organic compound (A) and the inorganic network is also one. If the number of the functional groups in the organic compound (A) is two or more, then the organic compound (A) is bound to the inorganic network with two or more covalent bonds. As a result, the inorganic network increases its strength. Therefore, the organic compound (A) preferably has two or more functional groups.

Inorganic Compound (B)

The inorganic compound (B) used in the present invention is a compound having a metal atom to which each of at least one functional group and at least one hydrolysable group is bound directly or via a connecting group. Here, the connecting group which is referred to in the phrase “bound directly or via a connecting group” is for example a —(CH₂)ₙ— group (n is positive integer), an allylene group,

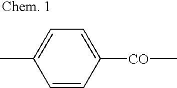

and a combination of the —(CH₂)ₙ— group and the allylene group. In the present invention, the metal atom is preferably bound directly to each of the functional group and the hydrolysable group.

The hydrolysable group is a group which gives a metal oxide when subjected to a hydrolysis reaction. Specific examples of the hydrolysable group encompass: an alkoxy group, an acetoxy group, and a chloro group. The alkoxy group is preferably a methoxy group, an ethoxy group, an n-propoxy group, an iso-propoxy group, an n-butoxy group, or a tert-butoxy group.

The metal atom in the inorganic compound (B) is preferably selected from the group consisting of Al, Sb, Zr, Ti, Cr, Si, La, Ni, Sn, and V, and more preferably, Si.

The inorganic compound (B) may be for example selected from a wide range of inorganic compounds which are used as commercially-available silane coupling agents. Particularly, a coupling agent having an amino group reacts with an oligomer or polymer each having alkyl halide, an amide compound, or an epoxy group. A coupling agent having a mercapto group well reacts with oligomer or polymer each having a double bond (for example, polyisoprene and polychloroprene). A coupling agent having an isocyanato group reacts with an amine compound to give urea derivative, and also reacts with a compound having an acid group to give urethane. A coupling agent having alkyl chloride reacts with a compound having an amino group or an epoxy group.

A method of hydrolyzing the hydrolysable group so that the hydrolysable group is condensed and the inorganic compound (B) turns into the metal oxide is selected from known methods. An example of the method is heating. When heating the inorganic compound (B), it is preferable to heat the inorganic compound (B) at 30° C. to 150° C. for 1 minute to 12 hours. Another example of the method of hydrolyzing the hydrolysable group is to use catalyst or the like.

A mixing ratio of the organic compound (A) to the inorganic compound (B) may be determined as appropriate depending on the kind or the like of each of the organic compound (A) and the inorganic compound (B); however, it is preferable that molar ratio of the functional group in the organic compound (A) to the functional group in the inorganic compound (B) be 1:10 to 10:1.

In the present invention, a network hybridized via a covalent bond between the organic compound (A) and the inorganic compound (B) is formed, and also an inorganic network is formed in such a manner that the inorganic compound (B) is hydrolyzed. As such, it is possible to obtain an organic-inorganic hybrid thin film which has high stability, high strength, and flexibility. Particularly, the present invention is characterized in that a thin film can be formed without complicated means.

A composite used in the present invention may contain another compound other than the organic compound (A) and the inorganic compound (B).

A polymer or alkoxide may be added to the composite as a third component. For example, tetraethoxysilane (Si(O-Et)₄) may be added. Such a compound is to be added for example to increase hardness of the composite. Further, for example in a case where the covalent bond is formed between an epoxy group and an amino group, polyethilenimine may be added. Here, polyethilenimine controls a hydrophilic property. Furthermore, the third component may contribute to strengthening of the covalent bond. Such a third component may be added in an amount of 5% by weight to 50% by weight with respect to total weight of the organic-inorganic hybrid thin film.

The composite used in the present invention may contain a substance which gives a function to the organic-inorganic hybrid thin film and is not involved in formation of a film structure. Such a substance may either be an organic compound or an inorganic compound, and an example of the substance is at least one selected from the group consisting of a pigment, a colorant, metal fine particles, metal-oxide fine particles, organic fine particles, an organic low-molecular substance, an organic polymer, a dendrimer, a biomolecule, a carbon nanotube, fullerne, a carbon black, and a clay mineral. The pigment may be selected from generally used fluorescent pigments such as rhodamine, pyrene, and porphyrin; and generally used functional pigments such as azobenzene and spiropyran. Examples of the colorant encompass: polycyclic colorants such as an azo colorant and a phthalocyanine blue; and inorganic colorant such as nickel titanium yellow. Examples of the metal fine particles encompass: gold superfine particles, silver superfine particles, platinum fine particles, and tungsten fine particles. Examples of the metal-oxide fine particles encompass: aluminum oxide, titanic oxide, silicone oxide, and tin oxide. Examples of the organic fine particles encompass: polystyrene latex particles, (meth)acrylamide particles, and polystyrene fine particles polymerized with divinylbenzene. Examples of the organic low-molecular substance encompass: functional molecules such as a carbazole derivative, a TTF (tetrathiafulvalene) derivative, a quinones derivative, a thiophene derivative, and a pyrrole derivative. Examples of the organic polymer encompass: a crystalline polymer such as polyethylene, polypropylene, and polyamide; and an amorphous polymer such as polystyrene, polycarbonate, and polysulphone. Examples of the biomolecule encompass: DNA, protein, phosphate, glucose, and ATP. Examples of the clay mineral encompass: zeolite, kaolinite, montmorillonite, and chlorite. Examples of the dendrimer encompass: a PMMA-type dendrimer, a thiophene-type dendrimer, and a poly(amideamine)dendrimer.

These substances may be contained in the composite used in the present invention in an amount of preferably 0.01% by weight to 80% by weight. Further, these substances may be contained in an amount of preferably 0.1% by weight to 40% by weight with respect to the organic-inorganic hybrid thin film that is to be obtained.

As so far described, in the production method of the present invention, the organic-inorganic thin film may be used as a thin film containing a variety of substances. For example, the organic-inorganic hybrid thin film containing the pigment can be used as an optical material. Further, the organic-inorganic hybrid thin film containing a metal oxide can be used as an interlayer insulating film.

Furthermore, the composition used in the present invention is produced generally by adding a resin or another substance etc. to a solvent. The solvent used here is not particularly limited; however, the solvent may be for example chloroform, cyclohexanone, diethylene glycol dimethyl ether, and ethyl lactate.

Here, the composite used in the present invention may be provided directly on a support, and may also be provided on the support with a layer therebetween, such layer as a sacrifice layer (described later).

Further, a surface on which the composite used in the present invention is to be provided is preferably washed in advance. The surface may be washed with an acid-containing solution, preferably with a piranha solution. Such a washing process makes it possible to more easily separate a polymerized resin composition (the organic-inorganic hybrid thin film of the present invention) from the support.

A method of layerwise providing the composition may be selected from a wide range of methods of providing a thin film, such as a spin-coating method and a dip-coating method.

When using the spin-coating method, it is preferable to perform it at a revolution speed of 600 rpm to 8000 rpm.

Further, the organic-inorganic hybrid thin film of the present invention can be adjusted in terms of its film thickness by adjusting a concentration of the resin in the composition, a condition of the spin-coating method, or the like.

In the present invention, it is preferable to: apply layerwise the composition used in the present invention to the support and thereafter; carry out a hydrolysis reaction on the composition to form a thin film and thereafter; separate the thin film from the support. Here, a method of separating the thin film from the support is selected from known methods.

The thin film is separated from the support preferably by providing the sacrifice layer on the surface of the support in advance and then removing the sacrifice layer afterwards. The sacrifice layer may be provided and removed by any method as long as the method does not cause a damage to the organic-inorganic hybrid thin film of the present invention. The sacrifice layer is removed preferably through a method in which the sacrifice layer and the thin film made by applying layerwise the composition and hydrolyzing the composition-applied layer (i.e., the organic-inorganic hybrid thin film) are dipped in a solvent that dissolves only the sacrifice layer but does not dissolve the organic-inorganic hybrid thin film. When performing this method, it is preferable to make a cut between the sacrifice layer and the organic-inorganic hybrid thin film in advance. This is preferable because it makes the solvent easily permeable between the sacrifice layer and the organic-inorganic hybrid thin film.

In the present invention, it is particularly preferable to employ, as the sacrifice layer, a polymer whose solubility in the solvent is changed by some external stimulation. Such a polymer is preferably a crosslinkable polymer, and more preferably a thermo-crosslinkable photodegradable polymer or a photo crosslinkable thermo-degradable polymer. An example of the thermo-crosslinkable photodegradable polymer is a polymer made of a combination of vinyl ether, a hydroxyl group or an acid polymer, and a photoacid generator. Specific examples of the thermo-crosslinkable photodegradable polymer are polymers disclosed in Japanese Patent Application Publication, Tokukaihei, No. 9-274320 A and Japanese Patent Application Publication, Tokukai, No. 2004-117878 A. On the other hand, an example of the photo crosslinkable thermo-degradable polymer is a polymer having an epoxy group on a side chain thereof. A specific example of the photo crosslinkable thermo-degradable polymer is a polymer disclosed in Chem. Mater. 2002, 14, 334-340. The use of such a thermo-crosslinkable photodegradable polymer or a photo crosslinkable thermo-degradable polymer is advantageous in that almost all solvents may be used in providing the composition of the present invention on the support.

The sacrifice layer is preferably 100 nm to 10 μm in thickness. Within the range, the sacrifice layer can be readily removed.

The support that can be used here is a glass substrate, a silicon wafer substrate, a mica substrate, a gold substrate, or the like. The sacrifice layer that can be used here is polyhydroxystyrene, polystyrene sulfonate, a semiconductor resist material, a thermo-polymerizable polymer, or the like. A solvent that is used in production of the sacrifice layer is preferably a solvent that does not cause a damage to the organic-inorganic hybrid thin film of the present invention. However, the solvent does not necessarily the one does not cause damage to the organic-inorganic hybrid thin film of the present invention, unless it goes against the gist of the present invention. An example of such a case that does not go against the gist of the present invention is a case where the composition of the present invention is provided layerwise after the solvent has completely vaporized.

An organic-inorganic hybrid thin film obtainable through the method of the present invention has an advantageous property that the thin films obtainable through the conventional methods have not been able to attain.

First, the production method of the present invention provides an organic-inorganic hybrid thin film that has a self-supportability. As used herein, the phrase “has a self-supportability” means a state where a layer serving as the organic-inorganic hybrid thin film maintains a shape of a thin film even after the support is removed.

Further, the production method of the present invention makes it possible to produce the following organic-inorganic hybrid thin films having the properties mentioned below.

(1) An organic-inorganic hybrid thin film which maintains the self-supportability even if a thickness thereof is reduced to for example 100 nm or less, further 50 nm or less, and particularly 10 nm to 50 nm.
(2) An organic-inorganic hybrid thin film having a surface area of 100 mm² or larger.
(3) An organic-inorganic hybrid thin film having an aspect ratio (a ratio of film size to film thickness) of 10⁴ or larger, further 10⁶ or larger, and particularly 10⁷ or larger.
(4) An organic-inorganic hybrid thin film having excellent dimensional stability, specifically having a dimensional accuracy of 1% or less with respect to the support.
(5) An organic-inorganic hybrid thin film having strength of for example 1 MPa or more, and further having strength of 10 MPa or more.
(6) An organic-inorganic hybrid thin film capable of semi-permanently maintaining the self-supportability (for example, 1 year or longer).
(7) An organic-inorganic hybrid thin film having excellent flexibility, for example, having ultimate expansion/contraction ratio of 0.1% or higher.
(8) An organic-inorganic hybrid thin film having a Young's modulus of 800 MPa or higher, and further having a Young's modulus of 1000 MPa or higher.
(9) An organic-inorganic hybrid thin film having strength of 10 MPa or higher.

A thickness of the organic-inorganic hybrid thin film of the present invention may be determined depending on a use thereof. For example, the thickness is 3 nm to 100 nm, and preferably 10 nm to 50 nm. The organic-inorganic hybrid thin film having a film thickness falling within the above ranges makes it possible to achieve flexibility that has not been achieved by a conventional film thickness and to increase substance permeability. Such an organic-inorganic hybrid thin film can be used as a precise protective film.

The organic-inorganic hybrid thin film of the present invention may have functionality by itself; however, a functional layer may be provided on a surface of the organic-inorganic hybrid thin film, or a functional material may be adhered to the surface of the organic-inorganic hybrid thin film to thereby make the organic-inorganic hybrid thin film have functionality. Examples of the functional layer encompass: a metal layer, a polymer layer, and a metal oxide layer. Examples of the functional material encompass: a pigment (particularly a pigment having a functional group, such as rhodamine isothiocyanate, fluorescamine, dansyl chloride, and dabsyl chloride), a colorant, a liquid crystal molecule, a metal fine particle, and a semiconductor fine particle and an oxide fine particle.

### EXAMPLES

The present invention is more specifically described with reference to the following Examples. In the following Examples, a raw material used, its amount and ratio, details of treatment and treatment processes may be suitably modified unless it goes against the gist of the present invention. Accordingly, the scope of the present invention should not be limitatively interpreted by the Examples described below.

### Example 1

Compounds used in the present Example are as follows:

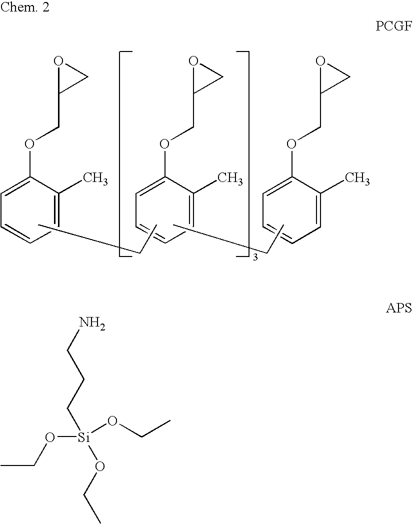

To a cresol type epoxy oligomer (PCGF, manufactured by Sigma-Aldrich, PCGF870), 1-aminopropyltriethoxysilane (APS, manufactured by Sigma-Aldrich) was added, and stirred at a room temperature for 24 hours. Thereafter, the resultant was diluted with chloroform so as to obtain an application solution. The application solution was prepared so that a resin content thereof was 1.0% by weight and molar ratio of functional groups (an epoxy group to an amino group) was 1:1.

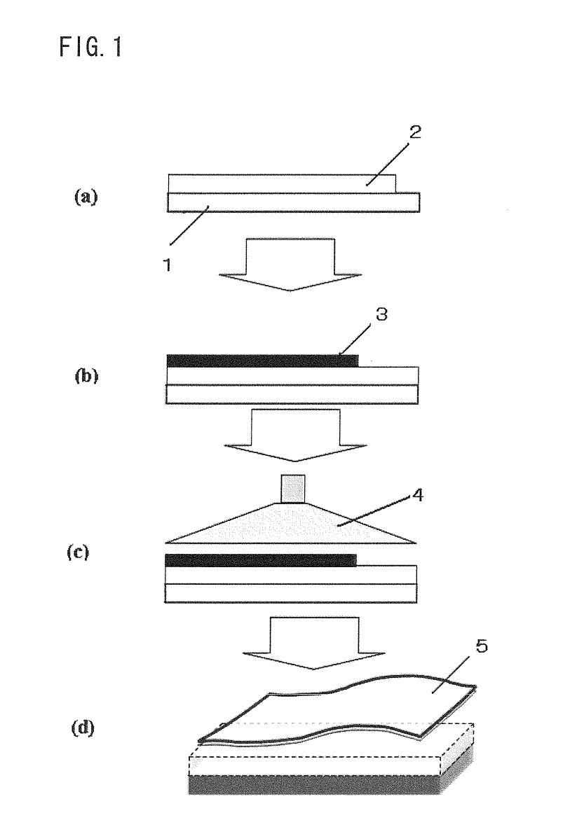

Next, the steps (a), (b), and (d) in FIG. 1 were carried out to produce an organic-inorganic hybrid thin film. Note that in the present example, the step (c) of FIG. 1 was not carried out. In FIG. 1, 1 indicates a silicon wafer substrate, 2 indicates a sacrifice layer, 3 indicates a layer made of a composition used in the present invention, and 5 indicates the organic-inorganic hybrid thin film of the present invention.

On the silicon wafer substrate, a polyvinyl phenol (PHS) layer (thickness: 100 nm) serving as the sacrifice layer was provided by a spin-coating method ((a) of FIG. 1). Next, on the sacrifice layer, the layer made of the composition used in the present invention was provided by applying and then spinning the application solution at 2000 rpm for 60 seconds ((b) of FIG. 1). A thickness of the layer made of the composition used in the present invention was 20 nm. The layer was heated at 120° C. for approximately 30 minutes so that the layer was subjected to a hydrolysis reaction, and then dipped in ethanol so that the sacrifice layer was dissolved. In this way, the inorganic-organic hybrid thin film of the present invention was separated ((d) of FIG. 1).

### Comparative Example 1

The same process as in Example 1 was carried out except that each of PCGF and APS was independently dissolved in chloroform and then the resultant solutions were mixed with each other to obtain an application solution. In this case, the application solution was to be applied layerwise with no covalent bond formed between PCGF and APS.

### Example 2

The same process as in Example 1 was carried out except that the application solution was prepared so that molar ratio of functional groups (the epoxy group to the amino group) was 1:2 so as to obtain an organic-inorganic hybrid thin film.

### Example 3

The same process as in Example 1 was carried out except that the application solution was prepared so that molar ratio of functional groups (the epoxy group to the amino group) was 1:0.5 so as to obtain an organic-inorganic hybrid thin film.

Results

The organic-inorganic hybrid thin films obtained in Examples 1 to 3 were checked visually. The visual observation found that the organic-inorganic hybrid thin films obtained in Examples 1 to 3 were transparent and uniform thin films. The organic-inorganic hybrid thin film obtained in Comparative Example 1 was found to have white turbidity which appeared to have occurred due to phase separation, and was not an uniform thin film. This confirmed that the direct mixing and stirring of PCGF and APS caused the epoxy group and the amino group to react with each other at a room temperature prior to the spin-coating process, thereby preventing the phase separation from occurring during the spin-coating process.

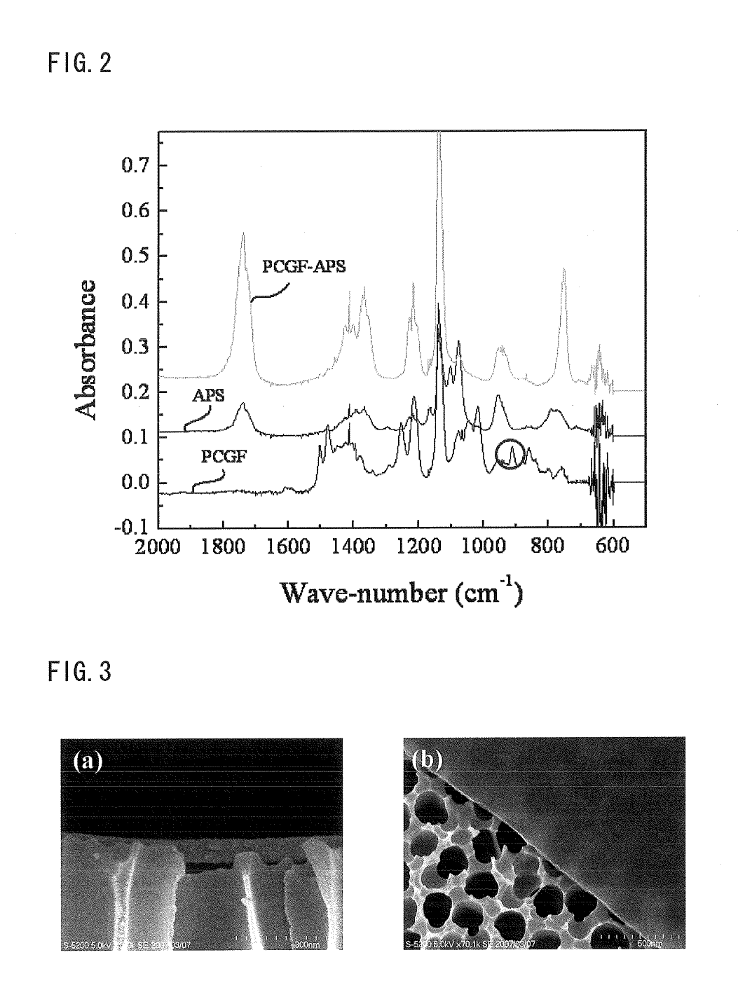

FIG. 2 is a graph showing results of measurements of IR spectra for (i) a thin film (PCGF-APS) provided directly on a gold substrate in such a manner that PCGF and APS were mixed directly with each other, diluted with chloroform, applied on the gold substrate, and then spun so that the thin film was formed, (ii) APS in a form of liquid, and (iii) PCGF in a form of powder. As clearly shown in FIG. 2, even in IR spectrum, PCGF-APS did not show a 910 cm⁻¹ peak (encircled part in FIG. 2) attributed to cyclic ether, which peak was observed in PCFG.

The organic-inorganic hybrid thin film obtained in Example 1 was transferred onto a porous alumina substrate, and then observed under a scanning electron microscope (SEM). FIG. 3 shows the result thereof. (a) of FIG. 3 is a photograph of a cross-sectioned surface of the organic-inorganic hybrid thin film, and (b) of FIG. 3 is a photograph of a surface of the organic-inorganic hybrid thin film. FIG. 3 showed that a film thickness of the organic-inorganic hybrid thin film was approximately 45±2 nm. Further, (b) of FIG. 3 showed that the cross-sectioned surface of the organic-inorganic hybrid thin film was not damaged even after the organic-inorganic hybrid thin film was transferred onto the porous alumina substrate whose surface was not flat. These results confirmed that the organic-inorganic hybrid thin film obtained in Example 1 was a strong thin film.

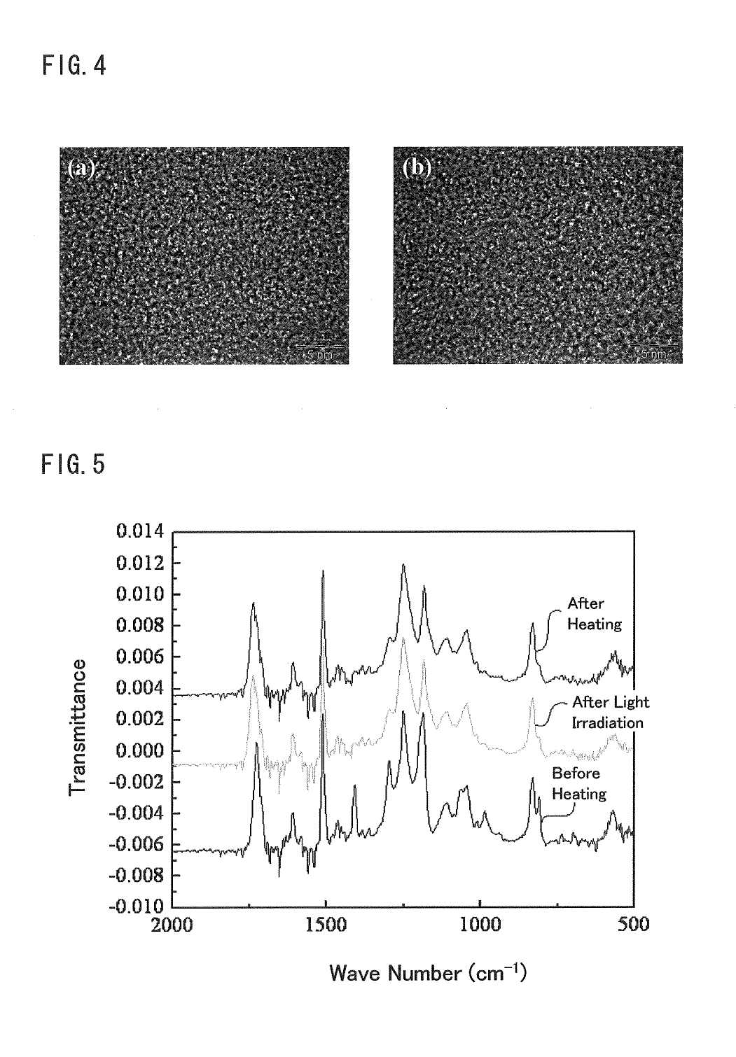

The organic-inorganic hybrid thin films obtained in Examples 1 and 2 were observed under a transmission electron microscope (TEM). FIG. 4 shows the results thereof. (a) of FIG. 4 is a photograph of the organic-inorganic hybrid thin film obtained in Example 1, and (b) of FIG. 4 is a photograph of the organic-inorganic hybrid thin film obtained in Example 2.

Neither the organic-inorganic hybrid thin film of (a) nor the organic-inorganic hybrid thin film of (b) was observed to have crystallized or agglutinated silica, and so found that they were good organic-inorganic hybrid thin films.

Each of the organic-inorganic hybrid thin films obtained in Examples 1 to 3 was measured in terms of: the film thickness by observing the organic-inorganic hybrid thin film under SEM; ultimate tensile strength and ultimate elongation by performing a method disclosed in Adv Mater., 2007, 19, 909-912; and Young's modulus by a SIEBIMM method (strain-induced elastic buckling instability measurement method).

Further, the same measurements as described above were performed also on (i) a film, having an interpenetrating polymer network structure of acrylate-zirconia, which is disclosed in Non-Patent Literature 1, and (ii) a film made of epoxy resin disclosed in Adv Mater., 2007, 19, 909-912. Table 1 shows the results thereof.

TABLE 1

| | | Ultimate | | |
|---|---|---|---|---|
| | Film | Tensile | Ultimate | Young's |
| | Thickness | Strength | Elongation | Modulus |
| | (nm) | (Pa) | (%) | (MPa) |
| Example 1 | 45 ± 2 | 4.7 × 10⁷ | 2.1 | 2240 |
| Example 2 | 44 ± 2 | 5.2 × 10⁷ | 1.1 | 1070 |
| Example 3 | 48 ± 2 | 3.3 × 10⁷ | 2.6 | 6840 |
| Epoxy Resin | 24 ± 2 | 2.2 × 10⁷ | 0.2 | 350 |
| Film of Non- | 60 | 4.5 × 10⁷ | 1.3 | 1100 |
| Patent Literature 1 | | | | |

It is clear from Table 1 that each of the organic-inorganic hybrid thin films obtained in Examples 1 to 3 was excellent in Young's modulus, ultimate tensile strength, and ultimate elongation. Particularly, it was confirmed that the organic-inorganic hybrid thin film of the present invention exhibited Young's modulus one digit larger than that of a known thin film made of epoxy resin having a thickness of 24±2 nm, which exhibited Young's modulus of 350 MPa.

Each of the organic-inorganic hybrid thin films (size: 10 cm²) obtained in Examples 1 to 3, which were suspended in ethanol, was absorbed into and then forced out of a pipette having an internal diameter of 320 μm. Here, the organic-inorganic hybrid thin films were not damaged. Further, each of the organic-inorganic hybrid thin films obtained in Examples 1 to 3 was transferred onto an anodized aluminum substrate (AAO substrate) and thereafter subjected to ethanol so that the ethanol penetrates the organic-inorganic hybrid thin film; however, the ethanol did not at all penetrate the organic-inorganic hybrid thin film.

### Example 4

Compounds used in the present Example are as follows.

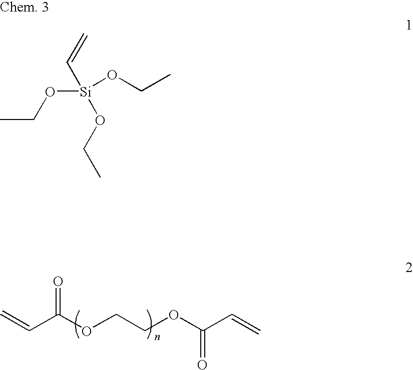

In Chem. 3, 1 is Triethoxyvinylsilane (manufactured by TOKYO CHEMICAL INDUSTRY CO., LTD.), which is known as a silane coupling agent, and 2 is an acrylic oligomer (manufactured by Mitsui Chemicals, Inc., R280).

The silane coupling agent 1 and the acrylic oligomer 2 were dissolved at a proportion of 1:1 (in volume) into chloroform. To the resultant solution, Darocure4265 (manufactured by Ciba-Geigy) serving as a photopolymerization initiator was added so as to obtain an application solution. The application solution was prepared so that a total weight of the silane coupling agent 1 and the acrylic oligomer 2 was 1% by weight. The photopolymerization initiator was added so that an amount thereof was 5% by weight with respect to the total weight of the silane coupling agent 1 and the acrylic oligomer 2 (0.05% by weight with respect to a whole application solution). The steps (a) to (d) in FIG. 1 were carried out so as to form the organic-inorganic hybrid thin film. In FIG. 1, 4 indicates a light irradiation apparatus.

To begin with, on a silicon wafer substrate (size: 4×4 cm), a polyvinyl phenol (PHS) layer (thickness: approximately 100 nm) serving as a sacrifice layer was provided by a spin-coating method ((a) of FIG. 1). Next, on the sacrifice layer, a layer made of a composition used in the present invention was provided by spin-coating the application solution at 2000 rpm for 60 seconds ((b) of FIG. 1). A thickness of the layer made of the composition used in the present invention was 40 nm. The layer made of the composition used in the present invention was irradiated with light in vacuum at 300 nm for 60 seconds by the light irradiation apparatus ((c) of FIG. 1). A light source used here was a mercury lamp, which performed light irradiation via a glass slide. After that, the resultant sample was heated at 120° C. for an hour, and thereafter, dipped in water so as to dissolve the sacrifice layer. In this way, the organic-inorganic hybrid thin film was separated ((d) in FIG. 1).

### Comparative Example 2

The same process as in Example 4 was carried out except that the step of heating at 120° C. for an hour was omitted.

### Comparative Example 3

The same process as in Example 4 was carried out except that the light irradiation was not performed.

### Example 5

The same process as in Example 4 was carried out except that the sacrifice layer was dissolved by dipping an organic-inorganic hybrid thin film in ethanol so as to obtain an organic-inorganic hybrid thin film.

### Example 6

The same process as in Example 4 was carried out except that Triethoxyvinylsilane (manufactured by TOKYO CHEMICAL INDUSTRY CO., LTD.) and divinylbenzen (manufactured by KANTO KAGAKU.) were used instead of the compounds used in Example 4, so as to obtain an organic-inorganic hybrid thin film.

Results

The organic-inorganic hybrid thin films obtained in Examples 4 to 6 were checked visually. The visual observation found no visual defects on the organic-inorganic hybrid thin films. In Comparative Examples 2 and 3, although the organic-inorganic hybrid thin films were in a form of layer while they were on the silicon wafer substrate, they were torn up when separated from the silicon wafer substrate.

In Example 4, IR spectrum was measured on the organic-inorganic hybrid thin film before and after heating at 120° C. for an hour, and after the light irradiation. FIG. 5 shows the result thereof. It is clearly shown in FIG. 5 that an 810 cm⁻¹ peak attributed to an acrylic group and a vinyl group disappeared after the organic-inorganic hybrid thin film was heated. This confirmed that both the acrylic group and the vinyl group were reacted.

As clearly shown in Examples 4 and 5, the sacrifice layer may be removed with use of either water or ethanol so as to obtain a superior organic-inorganic hybrid thin film. The organic-inorganic hybrid thin films thus obtained were stable both in the ethanol and water, and therefore the organic-inorganic hybrid thin films thus obtained were easily handled. These organic-inorganic hybrid thin films were excellent also in dimensional stability, and had a size nearly the same as the size of the silicon wafer substrate.

Further, the same process as in Example 4 was carried out except that an acrylic monomer 3 which is represented by the following chemical formula was used instead of the acrylic oligomer 2. As a result, it was confirmed that an organic-inorganic hybrid thin film thus obtained had the same kind of effects as that of the organic-inorganic hybrid thin film obtained in Example 4. The acrylic monomer 3 used here was manufactured by Sigma-Aldrich, and was added so that a proportion of the acrylic monomer 3 to the silane coupling agent 1 (in volume) was 1:1.

Chem. 4

(H₂C═CHC(═O)OCH₂)₄C 3

### Example 7

An organic-inorganic hybrid thin film was produced according to Example 1, except that a film thickness of the organic-inorganic hybrid thin film was 53.7 nm. The organic-inorganic hybrid thin film thus obtained was used to perform the following experiments.

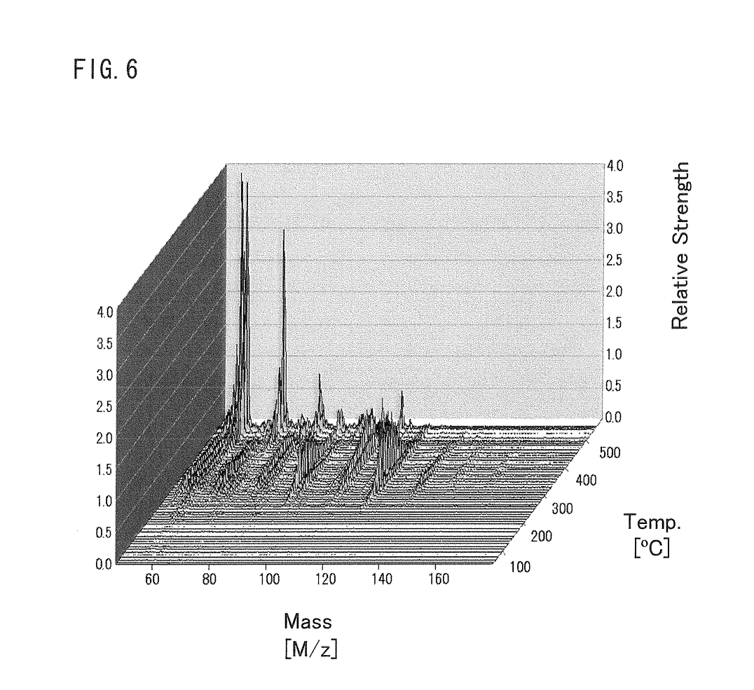

The organic-inorganic hybrid thin film obtained as described above was measured in terms of Thermal Desorption Spectrum (TDS), according to a method described in E. Ito, J. Noh, and M. Hara, Jpn. J. Appl. Phys., 2003, 42, 852-855. FIG. 6 shows the result thereof. In FIG. 6, a depth axis indicates temperature (unit: ° C.), a width axis indicates mass (unit: M/z), and a height axis indicates relative strength. FIG. 6 showed that fragmentation of the organic-inorganic hybrid thin film due to degradation of an epoxy components started at around 250° C. This indicates that the organic-inorganic hybrid thin film produced in Example 7 was a material excellent in heat resistance. Further, it was confirmed that the organic-inorganic hybrid thin film produced in Example 7 maintained its original form even after subjected to a harsh condition (i.e., burning at 600° C. for 30 minutes).

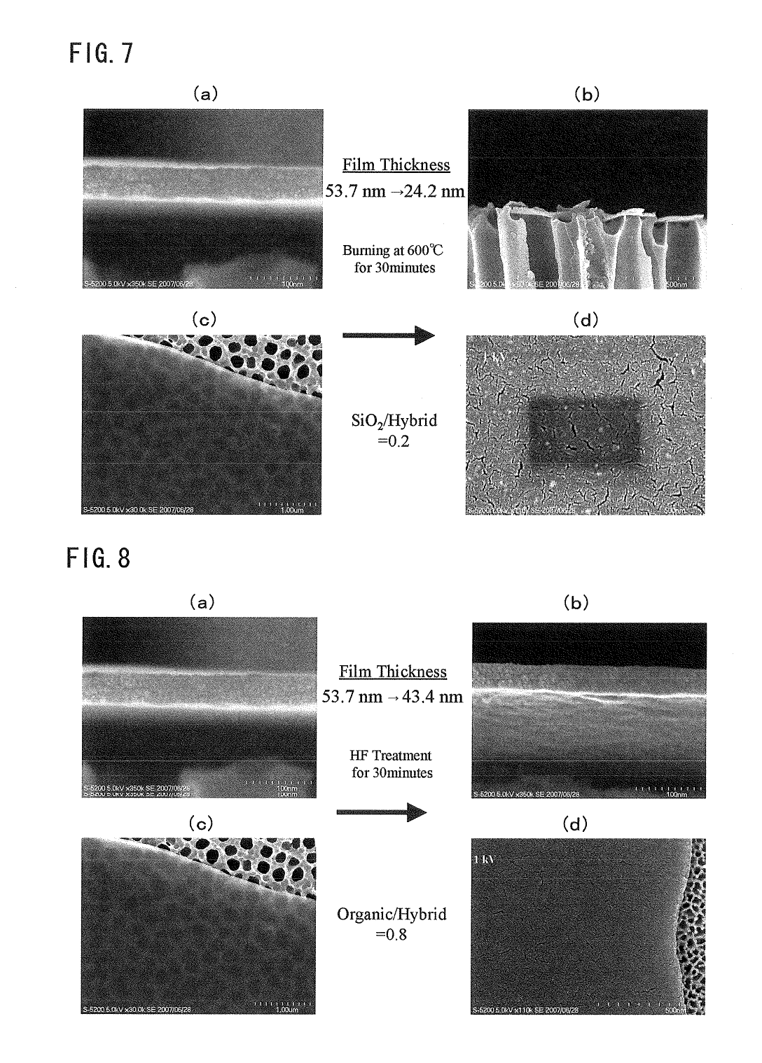

FIG. 7 shows SEM photographs of the organic-inorganic hybrid thin film produced in Example 7 that was transferred onto an AAO substrate, taken before and after the organic-inorganic hybrid thin film was burned. (a) and (b) of FIG. 7 are SEM photographs of a cross-sectioned surface of the organic-inorganic hybrid thin film, whereas (c) and (d) of FIG. 7 are SEM photographs of a surface of the organic-inorganic hybrid thin film. Further, (a) and (c) of FIG. 7 are SEM photographs of the organic-inorganic hybrid thin film which has not yet been burned, whereas (b) and (d) of FIG. 7 are SEM photographs of the organic-inorganic hybrid thin film which has been burned. As clearly shown in FIG. 7, it was confirmed that although the organic-inorganic hybrid thin film was made thinner from the film thickness of 53.7 nm to 24.2 nm due to carbonization of organic components after being burned, the organic-inorganic hybrid thin film maintained its original form. Although the organic-inorganic hybrid thin film which has been burned was weaker than that which has not yet been burned, the organic-inorganic hybrid thin film which has been burned maintained its original form even after the organic components were removed.

FIG. 8 shows SEM photographs of the organic-inorganic hybrid thin film produced in Example 7, which was transferred onto the AAO substrate, taken before and after the organic-inorganic hybrid thin film was dipped in 1% by weight of hydrogen fluoride (HF) solution for 30 minutes. (a) and (b) of FIG. 8 are SEM photographs of a cross-sectioned surface of the organic-inorganic hybrid thin film, whereas (c) and (d) are SEM photographs of a surface of the organic-inorganic hybrid thin film. Further, (a) and (c) of FIG. 8 are SEM photographs of the organic-inorganic hybrid thin film which has not yet been dipped in the HF solution, whereas (b) and (d) of FIG. 8 are SEM photographs of the organic-inorganic hybrid thin film which has been dipped in the HF solution. Although the organic-inorganic thin film was made thinner by approximately 20% from the film thickness of 53.7 nm to 43.4 nm, the organic-inorganic thin film was as tough as before being dipped. It is hypothesized that due to a covalent bond between inorganic and organic groups, the organic-inorganic hybrid thin film of the present invention was stable against an HF treatment which is an effective method of removing inorganic SiO₂ components.

1. An organic-inorganic hybrid thin film comprising:
an organic compound (A) having at least one functional group; and
an inorganic compound (B) having a metal atom, as a core, to which each of at least one functional group and at least one hydrolysable group is bound directly or via a connecting group,
the organic-inorganic hybrid thin film being structured such that a covalent bond is formed between the functional group in the organic compound (A) and the functional group in the inorganic compound (B), and a metal oxide is formed from the inorganic compound (B) through a hydrolytic reaction on the hydrolysable group in the inorganic compound (B).

2. The organic-inorganic hybrid thin film according to claim 1, wherein:
at least one kind of the functional group in the organic compound (A) and at least one kind of the functional group in the inorganic compound (B) are independently selected from the group consisting of: a vinyl group; a (meth)acrylic group; an epoxy group; a vinyl ether group; an amino group; a hydroxyl group; a carboxyl group; an alkoxycarbonyl group; a mercapto group; an alkyl halide group; an iso(thio)cyanate group; an acid halide group; a phosphono group; and an alkoxyphosphono group.

3. The organic-inorganic hybrid thin film according to claim 1, wherein at least one kind of the functional group in the organic compound (A) and at least one kind of the inorganic compound (B) are independently selected from the group consisting of: a vinyl group; a (meth)acrylic group; an epoxy group; and an amino group.

4. The organic-inorganic hybrid thin film according to claim 1, wherein the covalent bond is formed through a chain polymerization reaction, a condensation reaction, or an addition reaction.

5. The organic-inorganic hybrid thin film according to claim 1, wherein the organic compound (A) has two or more functional groups.

6. The organic-inorganic hybrid thin film according to claim 1, wherein the metal atom in the inorganic compound (B) is selected from the group consisting of Al, Sb, Zr, Ti, Cr, Si, La, Ni, Sn, and V.

7. The organic-inorganic hybrid thin film according to claim 1, wherein at least one kind of the hydrolysable group in the inorganic compound (B) is selected from the group consisting of an alkoxy group; an acetoxy group; and a chloro group.

8. The organic-inorganic hybrid thin film according to claim 1, wherein the inorganic compound (B) is a silane coupling agent.

9. The organic-inorganic hybrid thin film according to claim 1, wherein:
at least one kind of the functional group in the organic compound (A) and at least one kind of the functional group in the inorganic compound (B) are independently selected from the group consisting of: a vinyl group, a (meth)acrylic group, an epoxy group, and an amino group,
the metal atom in the inorganic compound (B) is Si, and
at least one kind of the hydrolysable group in the inorganic compound (B) is selected from the group consisting of an alkoxy group, an acetoxy group, and a chloro group.

10. A method for producing an organic-inorganic hybrid thin film, the method comprising:
shaping, into a form of layer, a composition containing (i) an organic compound (A) having at least one functional group and (ii) an inorganic compound (B) having a metal atom, as a core, to which each of at least one functional group and at least one hydrolysable group is bound directly or via a connecting group;
forming a covalent bond between the functional group in the organic compound (A) contained in the composition and the functional group in the inorganic compound (B) contained in the composition; and thereafter
causing a hydrolysis reaction on the hydrolysable group to form a metal oxide.

11. The method according to claim 10, wherein:
the step of shaping the composition into the form of layer and the step of causing the hydrolysis reaction are carried out after the step of forming the covalent bond.

12. The method according to claim 10, wherein:
the step of forming the covalent bond is carried out after the step of shaping the composition into the form of layer; and thereafter
the step of causing the hydrolysis reaction is carried out.

13. The method according to claim 10, the method further comprising:
forming a sacrifice layer on a surface of a support;
the step of shaping the composition into the form of film by applying layerwise the composition on a surface of the sacrifice layer; and thereafter
the step of causing the hydrolysis reaction on the composition to form a thin film on the surface of the sacrifice layer; and
removing the sacrifice layer so as to separate the thin film from the support.

14. The method according to claim 13, wherein:
the removal of the sacrifice layer is carried out by dissolving the sacrifice layer.

15. An organic-inorganic hybrid thin film produced with a method as set forth in to claim 10, the organic-inorganic hybrid thin film being in a range of 3 nm to 100 nm in thickness.
